(19) United States
(12) Patent Application Publication
(10) Pub. No.: US 2018/0045618 A1
(43) Pub. Date: Feb. 15, 2018

(54) DIAMOND SINTERED SAMPLING RELIEF VALVE

(71) Applicant: Cameron International Corporation, Houston, TX (US)

(72) Inventor: Gary M. Potten, Spring, TX (US)

(21) Appl. No.: 15/233,721

(22) Filed: Aug. 10, 2016

(51) Int. Cl. G01N 1/20; F16K 15/06; F16K 27/02; B23P 15/00

(52) U.S. Cl. CPC G01N 1/20; B23P 15/002; F16K 15/063; F16K 27/0209; G01N 2001/205; G01N 2001/2064

(57) ABSTRACT

A sampling system and relief valve are disclosed. The system can include a bypass loop for receiving a fluid. The system can also include sample receivers. The system further includes a sample extractor configured to obtain a sample of the fluid in the bypass loop to deposit to the one or more sample receivers. The system also includes a relief valve coupled between a fluid outlet of the sample extractor and at least one of the sample receivers. The relief valve includes a valve body having a fluid passage therethrough. The relief valve can also include a stem and a seat disposed in the valve body. The seat is configured to abut against the stem when the stem is biased into a closed position against the seat. At least a portion of the stem of the relief valve is formed of a diamond sintered material.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

In order to meet consumer and industrial demand for natural resources, companies often invest significant amounts of time and money in finding and extracting oil, natural gas, and other subterranean resources from the earth. Particularly, once a desired subterranean resource such as oil or natural gas is discovered, drilling and production systems are often employed to access and extract the resource. These systems may be located onshore or offshore depending on the location of a desired resource. Hydrocarbons are then transported for processing and refining.

In the hydrocarbon processing industry, analytical instrumentation is employed at various stages of processing to analyze the chemical composition of the fluids being transported and processed. Typically, the instrumentation analyzes a small sample taken from a hydrocarbon fluid stream. Sampling equipment, whether in-line or in a bypass loop, can be subject to severe erosion due to the volume of samples obtained and particulates in the samples.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Some embodiments of the present disclosure generally relate to a sampling relief valve. In one embodiment, the relief valve includes a valve body having a fluid passage therethrough and a stem disposed in the valve body so as to control flow in the fluid passage. The relief valve can also include a seat and a spring disposed in the valve body, with the spring biasing the stem toward the seat. Further, at least a portion of the stem of the relief valve includes a diamond sintered material.

Certain embodiments of the present disclosure generally relate to a system including a bypass loop for receiving a fluid. In one embodiment, the system also includes one or more sample receivers and a sample extractor having a fluid inlet and a fluid outlet. The sample extractor can obtain a sample of the fluid in the bypass loop to deposit to the one or more sample receivers. The system also includes a sampling relief valve coupled between the fluid outlet and the one or more sample receivers. The sampling relief valve includes a valve body having a fluid passage therethrough and a stem disposed in the valve body to control flow in the fluid passage. At least a portion of the stem of the relief valve is formed of a diamond sintered material. The relief valve also includes a seat positioned in the valve body so as to seal against the stem when the stem is in a closed position against the seat.

Still further embodiments of the present disclosure generally relate to a method that includes providing a stem base and a seat of a check valve. The method can also include providing diamond sintered material about the stem base of the check valve and permanently affixing the diamond sintered material about the stem base. Further, the method can also include disposing the stem base and diamond sintered material in a body of the check valve such that the diamond sintered material of the stem abuts the seat of the check valve.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings, wherein:

FIG. 1 generally depicts a sample extractor;

FIGS. 2A-2C depict a sample extractor system in use in a bypass loop of a pipeline;

FIG. 3 shows an external relief valve, in accordance with embodiments of the present disclosure, as can be used in the sample extractor system shown in FIG. 2A-2C;

FIG. 4 shows a cross-section of the external relief valve of FIG. 3 in accordance with one embodiment; and

FIGS. 5A and 5B show certain components of an external relief valve in accordance with embodiments of the present disclosure.

### DETAILED DESCRIPTION OF SPECIFIC EMBODIMENTS

Specific embodiments of the present disclosure are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Moreover, any use of “top,” “bottom,” “above,” “below,” other directional terms, and variations of these terms is made for convenience, but does not require any particular orientation of the components.

In pipeline sampling, a sampling check valve can be externally mounted at the outlet of a sample extractor device in a bypass loop. An external sampling check valve may be referred to herein as a “relief valve.” The relief valve opens each time the sample extractor extracts a sample, which may be on the order of 15,000 times a day. The relief valve provides sample size integrity and prevents leakage. In practice, the stem and seat of a relief valve may be subjected to extremely high velocity fluid across the stem and seat, and to sediment or sand in the sampled process product (e.g., crude oil). The relief valve may be set for between 100 and 1500 PSIG. Valves resilient to erosion have been attempted, including valve components of stainless steel, titanium nitride, or tungsten. In some cases, however, the resulting valve constructions may still fail quickly due to erosion or may be too expensive to manufacture for the particular application.

The present disclosure contemplates a relief valve having a stem component and a seat component. In some embodiments, at least a portion of the stem is formed of a diamond sintered material. For instance, in one embodiment the relief valve includes a ring of diamond sintered material affixed about the end of the stem to address erosion where the stem meets the seat. In some instances, the seat may also, or instead, include a diamond sintered material, such as at the surface where the stem and seat meet.

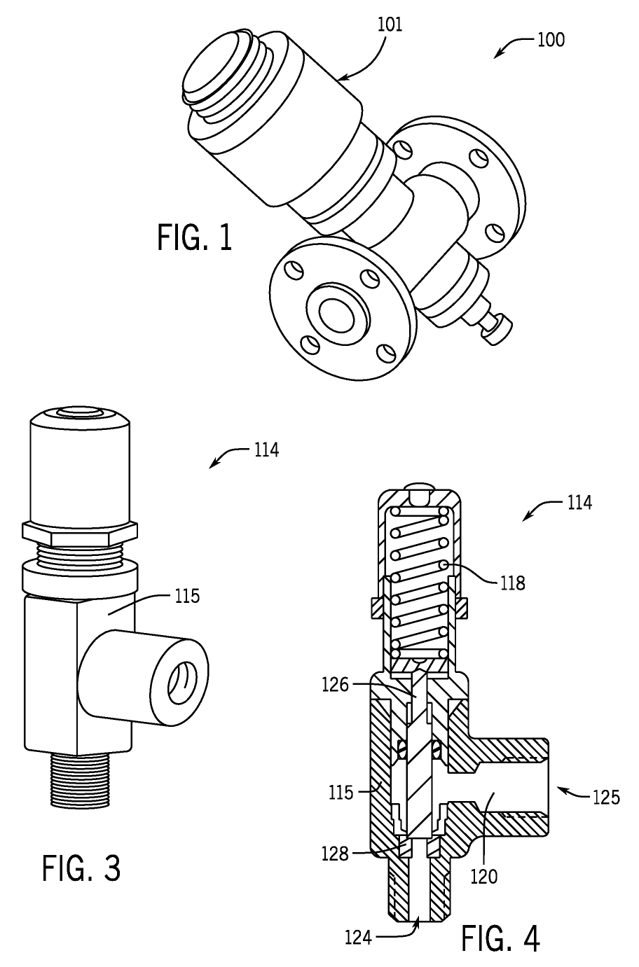

A sample extractor, such as sample extractor 100 of FIG. 1, extracts samples from liquids flowing in a nominal bypass line. Commercially available sample extractors may be powered by hydraulic power or air pressure. In an example configuration, a two-inch bypass loop bypasses a main pipeline, and sample extractor 100 obtains one-cc samples of product such as crude oil, refined hydrocarbons, and non-corrosive chemicals from the bypass loop. Sample extractors that obtain two-cc samples are also in common usage. Sample extractor 100 includes an actuation component 101.

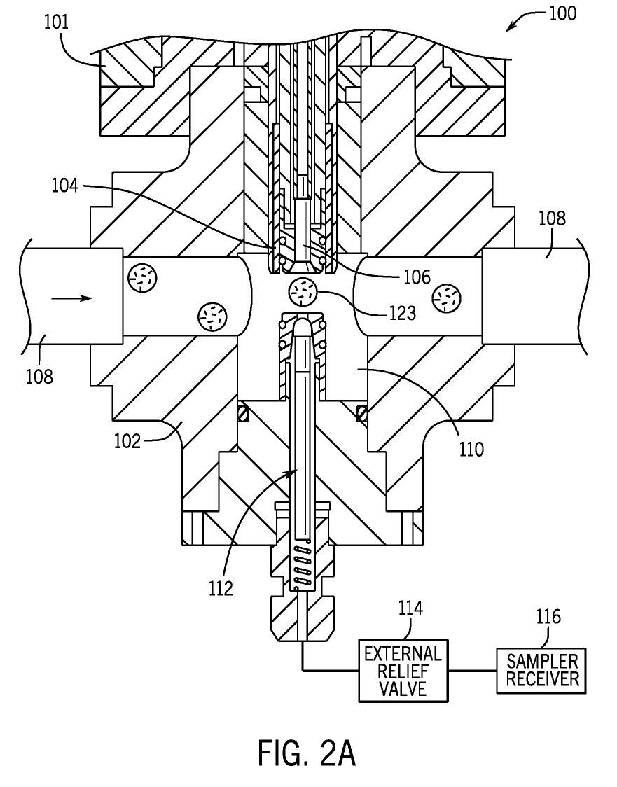

The function of a sample extractor, such as sample extractor 100, is well established and known by one of ordinary skill in the art. In an idle state, as shown in FIG. 2A, process product is free to flow through the sampler body 102 by way of the bypass line 108. When the sample extractor 100 is energized, air pressure (or hydraulic pressure) forces a piston of the actuation component 101 downward. The downward movement of the piston of the actuation component 101 forces a capture tube 104 downward through a chamber 110 of the body 102 to pass over a lower capture tube seal, thereby trapping a grab sample 123 of product (e.g., a one-cc or two-cc sample), as shown in FIG. 2B. Once the grab sample 123 is trapped by the capture tube 104, the grab sample 123 is pushed by sample tube 106 out the bottom of the sampler body 102 (as shown in FIG. 2C) through a check valve 112 internal to the sample extractor 100, out to external relief valve 114, and then to sampler receiver 116.

When the sample extractor 100 is de-energized, air is vented and applied to the underside of the piston of the actuation component 101, returning the capture tube 104 and sample tube 106 to their starting positions. The piston of actuation component 101 also returns to its starting position, with any vacuum relieved via a breaker incorporated into the sample tube 106. Process product continues to pass through the sampler body 102, and the sample extractor 100 is then ready for a subsequent grab.

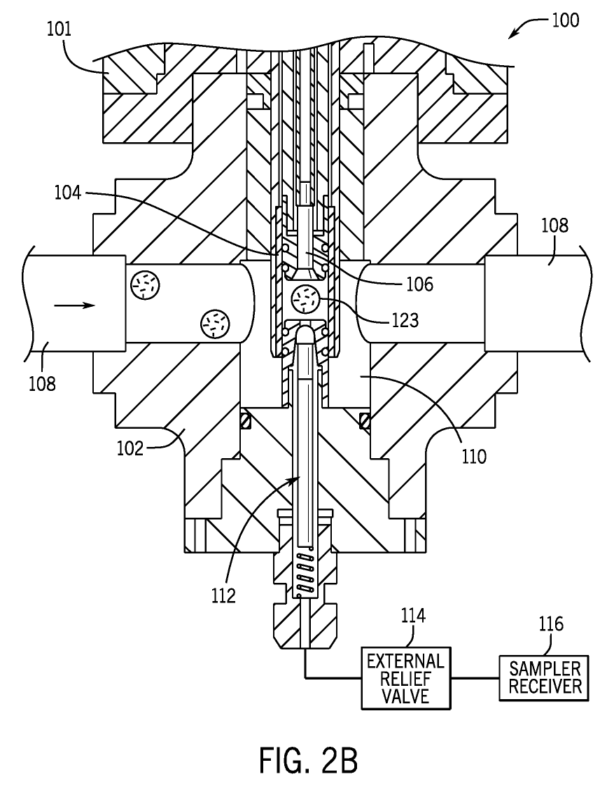

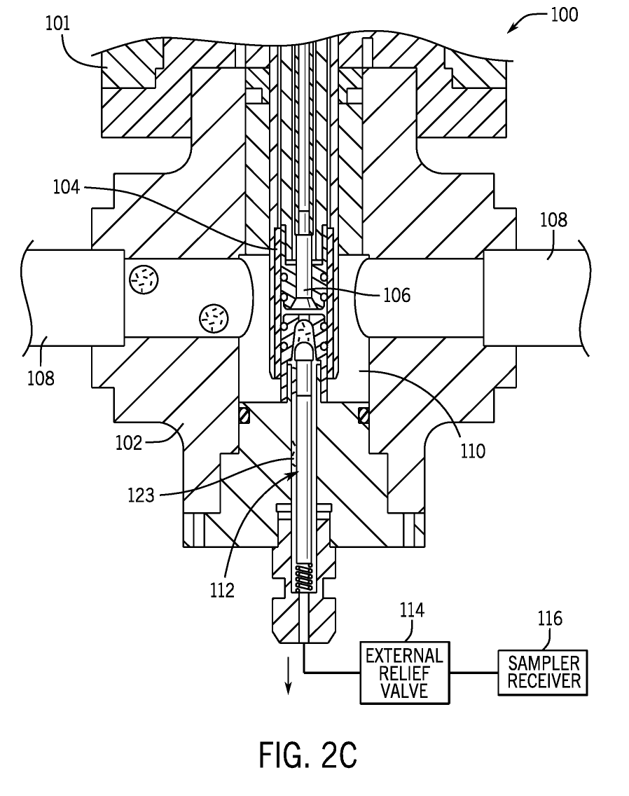

FIG. 3 depicts an example external relief valve 114 in accordance with embodiments of the present disclosure, as can be used with the sample extractor system shown in FIGS. 2A-2C. The body 115 of the relief valve 114 can be a stainless steel body. FIG. 4, in turn, is a cross-section of the external relief valve 114 of FIG. 3. The relief valve 114 is spring-biased with spring 118 maintaining the relief valve 114 in a closed position. A passage 120 through the body 115 of the relief valve 114 fluidly connects an inlet 124 and an outlet 125. When a pressure differential between the inlet 124 and outlet 125 overcomes the spring force of spring 118 (e.g., when sample tube 106 expels a fluid sample out of the sample extractor 100 to the relief valve 114), the relief valve 114 opens and the stem 126 moves away from the seat 128. The passage 120 through the body 115 of the relief valve 114 is closed when the stem 126 is in a closed position against the seat 128 (e.g., as shown in FIG. 4). In some embodiments, such as that shown in FIG. 4, the stem 126 may be formed entirely of a diamond sintered material. The seat 128 can also be formed (completely or partially) of a diamond sintered material in some instances.

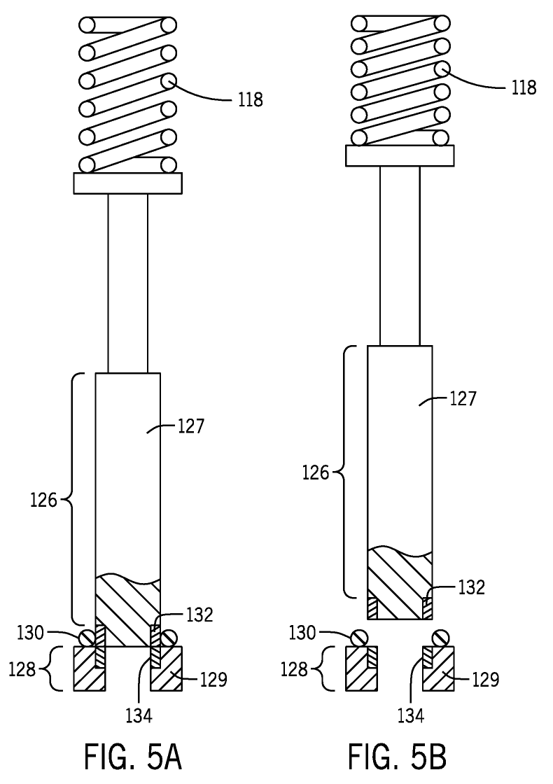

FIG. 5A shows another embodiment of an external relief valve 114 in closer detail in a closed position, without the body 115. The spring 118 biases the stem 126 into the closed position against the seat 128. In this embodiment, the stem 126 includes a base 127. The stem base 127 may be formed of a traditional material such as a nickel alloy, tungsten carbine, steel, or another suitable material. An outer ring 132 is disposed about the base 127 at the end of the stem 126. In one example embodiment, the outer ring 132 has a thickness on the order of five mm, and a height on the order of five mm. The outer ring 132 comprises a diamond sintered material, such as a polycrystalline diamond material. The outer ring 132 may be manufactured by combining diamond crystals (optionally synthetic) with metal powder, and then sintering the combination under pressure and at high temperature. The outer ring 132 may enable the stem 126 to better withstand erosion from sediment experienced by the stem, when compared to traditional valve stems. In an embodiment, the outer ring 132 may be threaded onto the stem base 127. Alternatively, the outer ring 132 may be brazed onto the stem base 127. In still another embodiment, an adhesive may adhere the outer ring 132 to the stem base 127.

Quad-ring 130 (or some other seal) is coupled to the seat 128, such that quad-ring 130 seals about the stem 126 seating against the seat 128 in the closed position. In an optional embodiment, as shown, the seat 128 may also include a portion 134 of diamond sintered material on the inner surface of a seat base 129 of the seat 128 in the form of an inner ring 134. In an example embodiment, the inner ring 134 may have a thickness and a height to approximately mirror the outer ring 132 on the stem 126, such that the areas of the stem 126 and seat 128 that abut one another are the areas of diamond sintered materials. The inner ring 134 may be brazed onto the seat base 129 of the seat 128. In still another embodiment, an adhesive may adhere the inner ring 134 to the seat base 129 of the seat 128.

FIG. 5B shows components of the external relief valve 114 of FIG. 5A in an open position. When the pressure differential between the inlet 124 and the outlet 125 overcomes the spring force of the spring 118, the spring 118 is compressed, and the stem 126 moves apart from the seat 128, allowing the fluid sample to pass through the relief valve 114.

In an embodiment, the stem base 127 and/or seat base 129 may be machined (e.g., to remove a corner) to produce a recess for the outer ring 132 and inner ring 134, respectively. Alternatively, the stem base 127 and/or seat base 129 may be forged to include a recess for the diamond sintered materials. In still further embodiments, the entirety of either the stem 126 or seat 128 may be formed of diamond sintered material, when cost effective.

Additionally, the diamond sintered material may include an angled pattern in the outer surface of the diamond sintered material in some instances. In still further embodiments, the diamond sintered material may be added to or layered on the stem base 127 and/or seat base 129 in any number of known ways, such as vacuum vapor deposition, sputtering and ion plating, methods of chemical vapor deposition, electrolytic plating, auto-catalytic plating, and the like.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

What is claimed:

1. A sampling relief valve, comprising:
a valve body having a fluid passage therethrough;
a stem disposed in the valve body, the stem configured to control flow in the fluid passage;
a seat disposed in the valve body, the seat configured to close against the stem when the stem is biased against the seat; and
a spring disposed in the valve body, the spring configured to bias the stem toward the seat;
wherein at least a portion of the stem comprises a first diamond sintered material.

2. The sampling relief valve according to claim 1, the stem further comprising a stem base disposed in the valve body and wherein the first diamond sintered material is coupled to the stem base.

3. The sampling relief valve according to claim 2, wherein the first diamond sintered material is permanently affixed to the stem base.

4. The sampling relief valve according to claim 2, wherein the first diamond sintered material is brazed to the stem base.

5. The sampling relief valve according to claim 1, wherein at least a portion of the seat comprises a second diamond sintered material.

6. The sampling relief valve according to claim 5, the seat further comprising a seat base disposed in the valve body and wherein the second diamond sintered material is coupled to the seat base.

7. The sampling relief valve according to claim 6, wherein the second diamond sintered material is permanently affixed to the seat base.

8. The sampling relief valve according to claim 6, wherein the second diamond sintered material is brazed to the seat base.

9. The sampling relief valve according to claim 1, further comprising a seal disposed in the valve body at the seat so as to seal against the stem when the stem is closed against the seat.

10. A system, comprising:
a bypass loop for receiving a fluid;
one or more sample receivers;
a sample extractor comprising a fluid inlet and a fluid outlet, wherein the sample extractor is configured to obtain a sample of the fluid in the bypass loop to deposit to the one or more sample receivers; and
a sampling relief valve coupled between the fluid outlet and the one or more sample receivers, the sampling relief valve comprising:
a valve body having a fluid passage therethrough;
a stem disposed in the valve body, the stem configured to control flow through the valve body; and
a seat disposed in the valve body about the fluid passage, wherein the seat is configured to seal against the stem when the stem is in a closed position against the seat;
wherein at least a portion of the stem comprises a first diamond sintered material.

11. The system according to claim 10, wherein the stem further comprises a stem base disposed in the valve body, and wherein the first diamond sintered material portion of the stem comprises a diamond sintered ring coupled about the stem base.

12. The system according to claim 10, wherein the seat further comprises a seat base disposed in the valve body and a second diamond sintered ring disposed in an interior of the seat base.

13. A method, comprising:
providing a stem base of a check valve;
providing a seat of the check valve;
providing diamond sintered material about the stem base of the check valve;
permanently affixing the diamond sintered material about the stem base; and
disposing the stem base and the diamond sintered material in a body of the check valve such that the diamond sintered material abuts the seat of the check valve.

14. The method according to claim 13, wherein providing the stem base further comprises machining a corner off a check valve stem.

15. The method according to claim 14, wherein providing the stem base further comprises machining the stem base to produce a recessed segment about an end of the check valve stem.

16. The method according to claim 15, wherein permanently affixing the diamond sintered material about the stem base includes affixing the diamond sintered material in the recessed segment about the end of the check valve stem.

17. The method according to claim 13, wherein permanently affixing the diamond sintered material further comprises brazing the diamond sintered material to the stem base.

18. The method according to claim 13, wherein permanently affixing the diamond sintered material further comprises adhering the diamond sintered material to the stem base.

19. The method according to claim 13, wherein providing the seat of the check valve includes:
providing a seat base of the check valve, the seat base having an interior surface; and
providing a second diamond sintered material sized to line at least a portion of the interior surface of the seat base of the check valve.

20. The method according to claim 19, wherein disposing the stem base and the diamond sintered material in the body of the check valve includes disposing the stem base and the diamond sintered material in the body of the check valve such that the diamond sintered material abuts the second diamond sintered material.
